(19) United States
(12) Patent Application Publication
(10) Pub. No.: US 2024/0404344 A1
(43) Pub. Date: Dec. 5, 2024

(54) SYSTEM AND METHODS FOR TRACKING ELECTRONICALLY TRACKABLE ITEMS WITHIN AN ACCESS CONTROL ENVIRONMENT

(71) Applicant: Towel tracker, Comstock Park, MI (US)

(72) Inventors: Steven Molewyk, Comstock Park, MI (US); John Molewyk, Comstock Park, MI (US); Michael Mieczkowski, Comstock Park, MI (US); Matthew Cheng, Comstock Park, MI (US)

(21) Appl. No.: 18/395,018

(22) Filed: Dec. 22, 2023

Related U.S. Application Data
(60) Provisional application No. 63/470,026, filed on May 31, 2023.

(51) Int. Cl. G07F 9/00; G07F 7/02; G07F 7/06; G07F 9/02

(52) U.S. Cl. CPC G07F 9/009; G07F 7/025; G07F 7/06; G07F 9/02

(57) ABSTRACT

A system and method for receiving, holding, and electronically identifying a plurality of electronically trackable items within an item dispensing device and an item return device. The system receiving user identification data presented at the dispensing device by a user configured to notify the dispensing device of intended user access to the dispensing device for at least one electronically trackable item, controlling user access of a user to the dispensing device to allow dispensing from the dispensing device of at least one electronically trackable item of the plurality of electronically trackable items, electronically identifying and storing a dispensing record of at least one dispensed electronically trackable item of the plurality of electronically trackable items associated with the user identification data.

A Non-Disposable Item Accounting System (NDIAS) provides accounting of non-disposable trackable items through the non-disposable item's life-cycle of dispensing, use, return, refurbishment and restocking for subsequent dispensing. The NDIAS includes at least one non-disposable item dispenser devices and at least one non-disposable item return device which are both in communication with at least one non-disposable item accounting server. Non-disposable items are tagged with Near-Field Communication (NFC) devices such as Radio Frequency Identification (RFID) physical tags or chips.

### CROSS-REFERENCE TO RELATED APPLICATIONS

This application claims the benefit of U.S. Provisional Patent Application Ser. No. 63/470,026 filed May 31, 2023. The disclosure of the applications listed above is incorporated herein by reference in its entirety.

### BACKGROUND

### Field

Athletic facilities at universities, colleges, and other athletic facilities, as well as health clubs, gyms, spas, and other such businesses or entities may provide reusable items, for example, clean towels, for users of the facilities. Similarly, hotels, resorts, and the like may also provide reusable items to users. The users are typically expected to return the used reusable items prior to leaving the facility, wherein the reusable items are prepared to be made available for future users. Also, hospitals or other such medical facilities may provide reusable items, for example, clean garments or scrubs, for various personnel that are returned to the facility for laundering and redistribution to the personnel. For example, uniforms or other garments may be distributed to users in a variety of settings and returned for laundering. Still further, a variety of items from a storage area may be provided to users for a period of time. For example, in a machine shop, production facility, or construction site, a number of tools may be stored at a “tool crib” or other facility, and individual workers can remove the tools for use for a period of time. In such cases, a system for tracking the tools or other articles may be utilized.

The increasing need for seamless user data acquisition solutions for the NDIAS systems into existing facility Access Control Systems (ACS) at hospitality facilities such as hotels and resorts, athletic clubs, and hospitals, has led to the development of several methodologies, as disclosed herein, that integrate the NDIAS into the existing Access Control OEM Systems (ACOS). ACOS features that enable integration with the NDIAS include encrypted data on user access credentials, e.g., magnetic stripe cards, RFID cards, wristbands, Bluetooth near-field communication (NFC) “mobile” keys, etc.

While each of these ACOS features have their unique benefits, both work best when integrated to work as a “one-stop” automated system.

### Description of Related Art

Applicant identifies their previous related U.S. patents, U.S. Pat. No. 8,362,878, issued on Jan. 29, 2013, being filed on Jun. 14, 2010 and having a priority publication U.S. Pat. Pub. No. US 2011/0304433 dated Dec. 15, 2011, and U.S. Pat. No. 9,717,352, issued on Aug. 1, 2017, being filed on Jul. 6, 2015 and having a priority publication U.S. Pat. Pub. No. US 2015/0366378 dated Dec. 24, 2015.

U.S. Pat. Nos. 8,362,878 and 9,717,352 describe a system for dispensing, receiving, and tracking towels or other items includes a cabinet structure having first and second interior spaces. An access door provides access to the first interior space, and a return door permits items to be returned to the second interior space. An RFID system conducts read operations to determine how many items having RFID tags are disposed in the first and second interior spaces. The system determines what items have been removed from the first interior space, and associates removed items with specific users. The RFID system conducts read operations as items are returned to the second interior space and credits the user.

### BRIEF SUMMARY

It should be appreciated that this Brief Summary is provided to introduce a selection of concepts in a simplified form that are further described below in the Detailed Description. This Brief Summary is not intended to be used to limit the scope of the claimed subject matter.

In some aspects, the techniques described herein relate to a system configured to prepare an unreturned record of an unreturned electronically trackable item associated with a user, the system including: a dispensing device configured: to receive, hold, and electronically identify a plurality of electronically trackable items within the dispensing device; to receive user identification data presented at the dispensing device by a user configured to notify the dispensing device of intended user access to the dispensing device for at least one electronically trackable item; to control user access of a user to the dispensing device to allow dispensing from the dispensing device of at least one electronically trackable item of the plurality of electronically trackable items; to electronically identify and store a dispensing record of at least one dispensed electronically trackable item of the plurality of electronically trackable items associated with the user identification data; and to transmit the dispensing record to a remote central electronically trackable item management system; a return device configured: to receive, electronically identify and store a return record of at least one returned electronically trackable item corresponding to the at least one dispensed electronically trackable item; and to transmit the return record to the remote central electronically trackable item management system; an access control device configured to receive user presented identification data presented by the user at the dispensing device and to allow user access to the dispensing device based on receiving the user presented identification data; the remote central electronically trackable item management system configured: to receive a plurality of dispensing records and a plurality of return records from at least one dispensing device and at least one return device, respectively; and to compile an unreturned record of at least one unreturned electronically trackable item and an associated user based on information in the user presented identification data presented by the user and collected at the dispensing device in the dispensing record, the unreturned record being calculated by taking a difference between the plurality of dispensing records and the plurality of return records; and a report system, in communication with the remote central electronically trackable item management system, the report system configured, at one of a predetermined time of day or a predetermined time period, to at least one of: communicate the unreturned record via electronic communication; and provide a web-based browser interface to view the unreturned record.

In some aspects, the techniques described herein relate to a method of preparing and transmitting a dispensing record for an electronically trackable item, the method including: reading user presented identification data from a user key device presented at a dispensing device configured to dispensing at least one electronically trackable item; allowing, based on the user presented identification data, user access to the dispensing device by: reading at least one electronically trackable item and generating and storing a first dispensing record of the at least one electronically trackable item; and unlocking a controllable lock on an opening on the dispensing device; determining the opening on the dispensing device is returned to a closed position and locking the opening based on determining the opening is in the closed position; reading an interior portion of the dispensing device of any remaining electronically trackable items and generating and storing a second dispensing record including any remaining electronically trackable items; determining at least one dispensed electronically trackable item by calculating a difference between the first dispensing record and the second dispensing record; creating a third dispensing record including the at least one dispensed electronically trackable item and information from the user presented identification data; and transmitting the third dispensing record to a central electronically trackable item management system.

In some aspects, the techniques described herein relate to a method preparing and transmitting a return record for an electronically trackable item, the method including: reading at least one electronically trackable item in an interior portion of a return device configured to receive and store a plurality of electronically trackable items, and generating and storing a first return record; determining an opening on the return device is returned to a closed position; reading, based on determining the opening is returned to the closed position, the interior portion of the return device for all electronically trackable items and generating and storing a second return record including all electronically trackable items; determining at least one return electronically trackable item by calculating a difference between the first return record and the second return record; creating a third return record including the at least one return electronically trackable item and a time corresponding to when the opening on the return device is returned to the closed position; and transmitting the third return record to a central electronically trackable item management system.

In some aspects, the techniques described herein relate to a method of generating and transmitting an inventory report for an electronically trackable item management system, the method including: receiving, from a dispensing device configured to dispensing an electronically trackable item, a dispensing report including a plurality of dispensing records each identifying at least one dispensed electronically trackable item, an associated user identifier information, and a dispensing time of the at least one dispensed electronically trackable item; receiving, from a return device configured to receive an electronically trackable item, a return report including a plurality of return records each identifying at least one returned electronically trackable item and a return time of the at least one returned electronically trackable item; creating a master inventory report by merging the plurality of dispensing records and the plurality of return records; generating an unreturned inventory report by removing dispensing records in the plurality of dispensing records from the master inventory report having matching electronically trackable item identifiers to return records in the plurality of return records in the master inventory report; associating at least one unreturned electronically trackable item and the associated user identifier information in the unreturned inventory report; and transmitting the unreturned inventory report based on one of a predetermined time of day or a predetermined period of time.

### BRIEF DESCRIPTION OF THE FIGURES

The aspects will be better understood from the following detailed description with reference to the drawings, which are not necessarily drawing to scale and in which:

FIGS. 1A-C illustrate a sequence in time of a dispensing unit reading electronically trackable items held inside before a dispensing door is opened, opening the dispensing door, and reading all remaining electronically trackable items after the dispensing door is closed;

FIGS. 1D and 1E illustrate a sequence in time of a return unit configured to receive a previously dispensed electronically trackable item, reading all electronically trackable items held inside, and allowing access for the used electronically trackable items to be removed from the return unit;

FIG. 2 illustrates a first system diagram including dispensing and return units that directly communicate with a remote item transaction manager system;

FIG. 3 illustrates transaction schematic diagram of the first system diagram;

FIG. 4 illustrates a second system including dispensing and return units that directly communicate with a remote item transaction manager system and a bridge access control server configured to communicate with the remote item transaction manager system;

FIG. 5 illustrates transaction schematic diagram of the second system diagram;

FIG. 6 illustrates a third system including dispensing and return units that directly communicate with a remote item transaction manager system and a dispensing unit that communicates with a membership server via an API call;

FIG. 7 illustrates transaction schematic diagram of the third system diagram;

FIG. 8 illustrates a fourth system including dispensing and return units that do not directly communicate with a remote item transaction manager system, but are independently audited for item transaction reporting data;

FIG. 9 illustrates transaction schematic diagram of the fourth system diagram;

FIG. 10 illustrates a method of preparing and transmitting a dispensing record for an electronically trackable item;

FIG. 11 illustrates a method preparing and transmitting a return record for an electronically trackable item;

FIG. 12 illustrates a method of generating and transmitting an inventory report for an electronically trackable item management system; and

FIG. 13 a schematic diagram of an exemplary hardware environment that can be used to implement the aspects described herein.

### DETAILED DESCRIPTION

The following disclosure clarifies the methods and systems of seamless integration of the Non-Disposable Item Accounting System (NDIAS) with an existing Access Control OEM Systems (ACOS), and related methods of operation of the ACOS with the integrated NDIAS.

Each NDIAS dispenser and return device may work independently of all other systems in the facility. The NDIAS dispenser and return device only requires a 120 VAC and 2.5 amps power supply to operate. In addition, a steady Wide Area Network (WAN), for example, an internet connection, is needed if multiple units are on-facility, web-portal reporting is desired, or if a live connection, (API, SSH, etc.), is being used to authenticate guest/member/staff access credentials within the facility. Hard wired Wide Local Area Network (WLAN) or WAN is recommended in the event the facility is charging guests/members/staff for lost non-disposable items. Each NDIAS dispenser and return device contains a local server that may independently run the full guest/member/staff facing operations of the device including:
Hosting the local instance of the NDIAS System Manager which manages the check out and check in of RFID tagged non-disposable items;
Taking inventory of the non-disposable items in both the dispensing device and the return device by non-disposable item RFID tag serial number;
Allowing known guest/member/staff to access clean or dispensable non-disposable items provided they have the correct access credentials required for the facility; and
Managing maintenance staff access to restock clean or dispensable non-disposable items and remove used or returned non-disposable items.

The NDIAS System Manager data is securely transmitted via WAN to a secure NDIAS cloud-based server where site level checked out data is aggregated and eliminations are calculated based on return data, (for example, if a non-disposable item is checked out at Dispenser Device 1 and returned to Return Device 3, the NDIAS cloud-based server will adjust the non-disposable item status to “returned”).

Site data is accessed by the facility through a secure web-portal created specifically for the facility. A secure web portal reports non-disposable item usage in near-real time including:
Guest/member/staff non-disposable item usage;
Guest/member/staff non-disposable item losses;
Laundry Supply Chain non-disposable item losses;
Non-disposable item inventory within each dispense/return device;
Non-disposable item inventory across the facility;
Historical usage of guest/member/staff losses;
Historical usage of Laundry Supply Chain losses;
Check Out Tomorrow Report-used by hospitality facilities to know which guests to charge for lost non-disposable items for the next day guest checkouts; and
Guest/member/staff non-disposable item loss reports-used by the facilities to know which guest/member/staff has lost non-disposable items.

Data can be accessed through the secure NDIAS System web-portal via WAN or pushed as an e-mail which may contain a preset report, (e.g., Checkout Tomorrow Report). As an example, the NDIAS web portal can publish a report each evening at 1:00 AM sent via e-mail to the facility night auditor which shows which guest/member/staff has not returned non-disposable items.

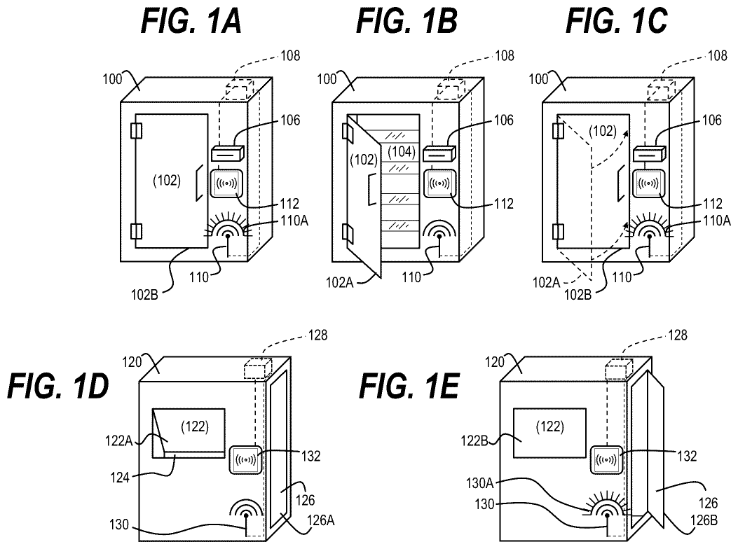

With reference to FIGS. 1A-C, the following figures illustrate a sequence in time of a trackable item dispensing unit 100 reading electronically trackable items held inside a dispensing unit interior compartment 104 before a dispensing unit access door 102 is opened, opening the dispensing unit access door 102, and reading all remaining electronically trackable items after the dispensing door is closed.

With reference to FIGS. 1A-1B, a trackable item dispensing unit 100 includes a dispensing unit access door 102 that is user operable between an access door open position 102A, allowing user access to a dispensing unit interior compartment 104, and an access door closed position 102B. A dispensing unit access device 106 is connected to a dispensing unit internal server 108 and is configured to allow a user to present an access key or access device thereto, wherein the dispensing unit internal server 108 may either unlock the dispensing unit access door 102 to the user, or may verify certain user provided access credentials in the data read from the presented access key or access device before unlocking the dispensing unit access door 102.

When a user presents their access key or access device to the dispensing unit access device 106, before the dispensing unit access door 102 opens, the dispensing unit internal server 108 causes a dispensing unit RFID reader 110 to be activated for an RFID sensing event 110A to electronically read all the electronically trackable items retained in the dispensing unit interior compartment 104.

Once the dispensing unit access door 102 is in the access door open position 102A, the user may retrieve one or more trackable items from the dispensing unit interior compartment 104.

With reference to FIG. 1C, after the user has retrieved the one or more trackable items form the dispensing unit interior compartment 104, the dispensing unit access door 102 is returned to the access door closed position 102B and the dispensing unit internal server 108 senses the dispensing unit access door 102 being in the access door closed position 102B. Thereafter, the dispensing unit RFID reader 110 is caused by the dispensing unit internal server 108 to have an RFID sensing event 110A again to read all the remaining electronically trackable items retained in the dispensing unit interior compartment 104. A comparison is made between the first RFID sensing event 110A illustrated in FIG. 1A and the subsequent RFID sensing event 110A illustrated in FIG. 1B, wherein the dispensing unit internal server 108 determines which unique RFID chips associated with respective trackable items have been removed from the dispensing unit interior compartment 104.

A dispense unit wireless transceiver 112 may be located on or within the trackable item dispensing unit 100 such that a facility employee can request a report from the dispensing unit internal server 108 that includes records of times, user information and unique RFID chips associated with respective trackable items have been removed from the trackable item dispensing unit 100 since a previous request. The requested report may be transmitted from the dispense unit wireless transceiver 112 to a device carried by the facility employee or may be transmitted by the dispensing unit internal server 108 to a local facility device or remote item transaction management system.

The dispensing unit internal server 108 may be in communication with the dispensing unit access device 106, the dispensing unit RFID reader 110 and the dispense unit wireless transceiver 112, and the dispensing unit internal server 108 may further communicate with an Original Equipment Manufacturer (OEM) access control system of a local facility and/or a remote item transaction management system 250, (as discussed below).

With reference to FIGS. 1D and 1E, the following figures illustrate a sequence in time of a trackable item return unit 120 configured to receive a previously dispensed electronically trackable item from the trackable item dispensing unit 100, reading all electronically trackable items held inside the return unit interior compartment 124, and allowing facility employee access for the used electronically trackable items to be removed from the trackable item return unit 120 via a return unit access door 126.

With reference to FIGS. 1D-1E, a trackable item return unit 120 includes a return unit access door 122 that moves between an access door open position 122A, to enable trackable items to be returned on a return unit interior compartment 124, and an access door closed position 122B that may trigger a RFID sensing event 130A from a return unit RFID reader 130 of all RFID equipped trackable items in the return unit interior compartment 124 of the trackable item return unit 120.

A return unit access door 126 is provided on another side of the trackable item return unit 120 to allow a facility employee to remove the returned items from the return unit interior compartment 124 of the trackable item return unit 120. A return unit internal server 128 may cause the return unit RFID reader 130 to enable a RFID sensing event 130A to read the RFID equipped return items upon the facility employee presenting access credentials 217 at a return unit wireless transceiver 132, and/or upon determining that the return unit access door 126 has been moved from an access door open position 126B to an access door closed position 126A after any items have been removed from the return unit interior compartment 124 of the trackable item return unit 120.

The return unit internal server 128 may be in communication with the return unit RFID reader 130 and the return unit wireless transceiver 132, and the return unit internal server 128 may further communicate with an OEM access control system of a local facility and/or a remote item transaction management system 250, (as discussed below).

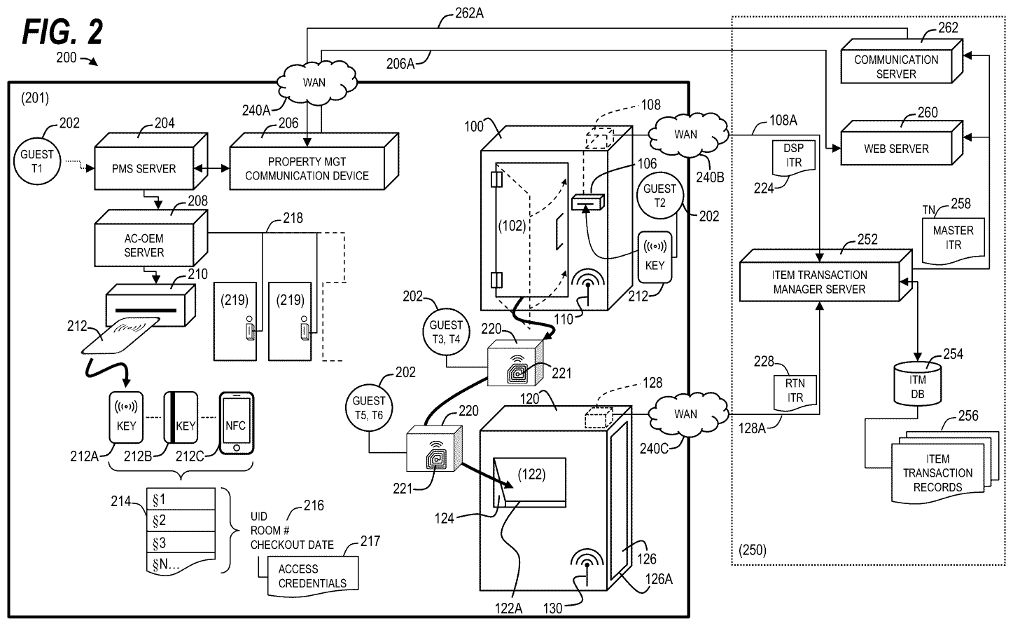

With reference to FIG. 2, a first trackable item system 200 includes at least one trackable item dispensing unit 100 and at least one trackable item return unit 120 that directly communicate with an item transaction management system 250.

For example, the first trackable item system 200 of FIG. 2, may, for example, include hospitality facilities using the NDIAS are interested in knowing which guest/member/staff has lost non-disposable items during their stay wherein the NDIAS prepares a corresponding report on the night before the guest/member/staff checks out from the facility. As a result, a Checkout Tomorrow report summarizes which guest/member/staffs has outstanding lost non-disposable items who are checking out the next day.

For hospitality facilities interested in monetizing lost non-disposable items for the duration of a guest's stay at the facility, a room number and guest/member/staff checkout date are necessary data needed by the NDIAS. These data items are used to create the Check Out Tomorrow report. In most cases, the Check Out Tomorrow report may be used by the facility night auditor staff to quickly charge guest/member/staff checking out the next day for lost non-disposable items.

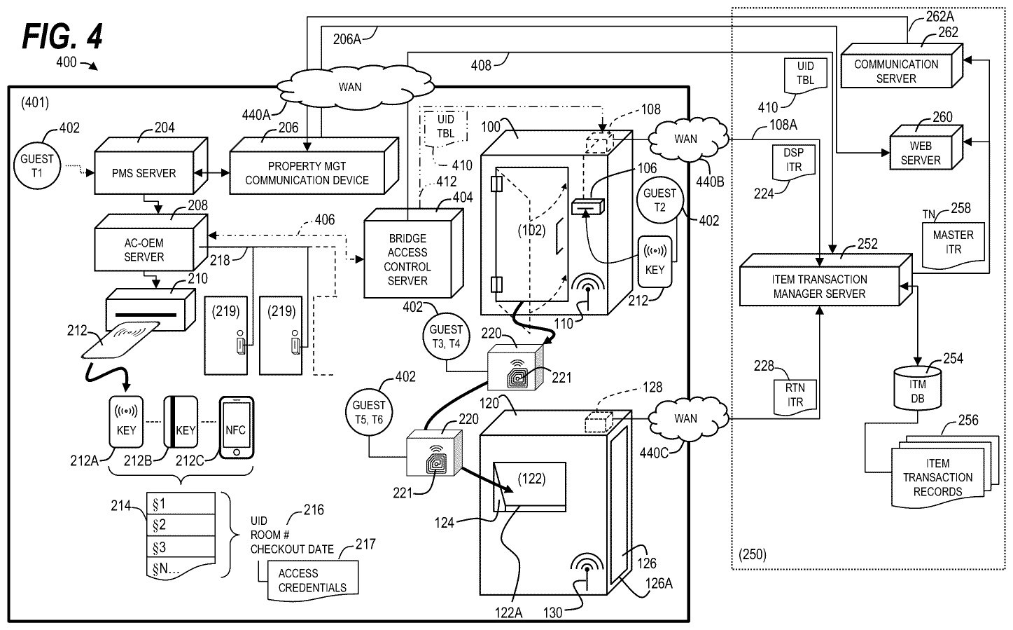

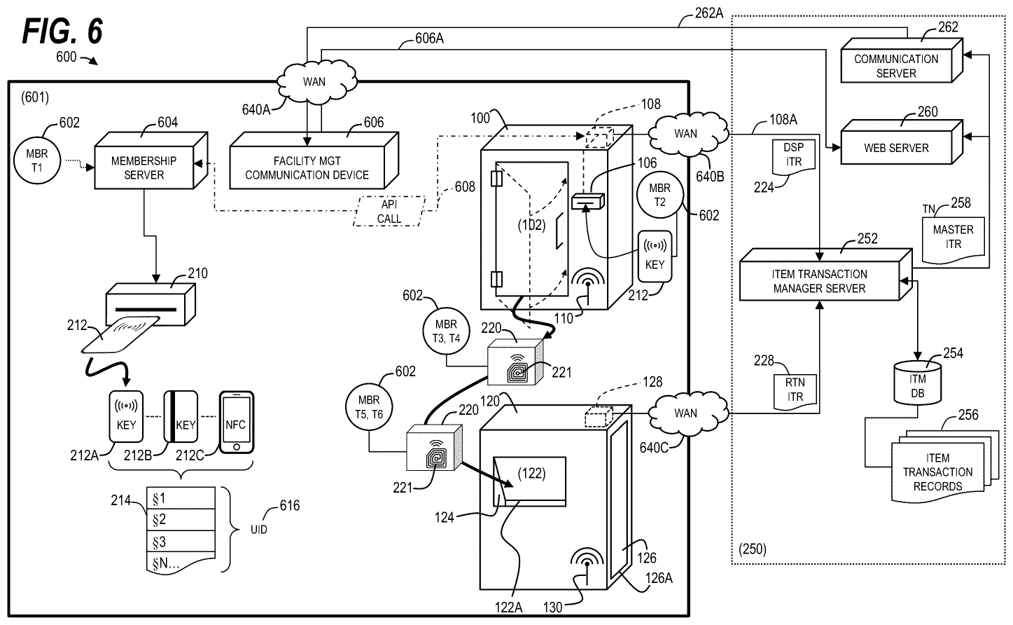

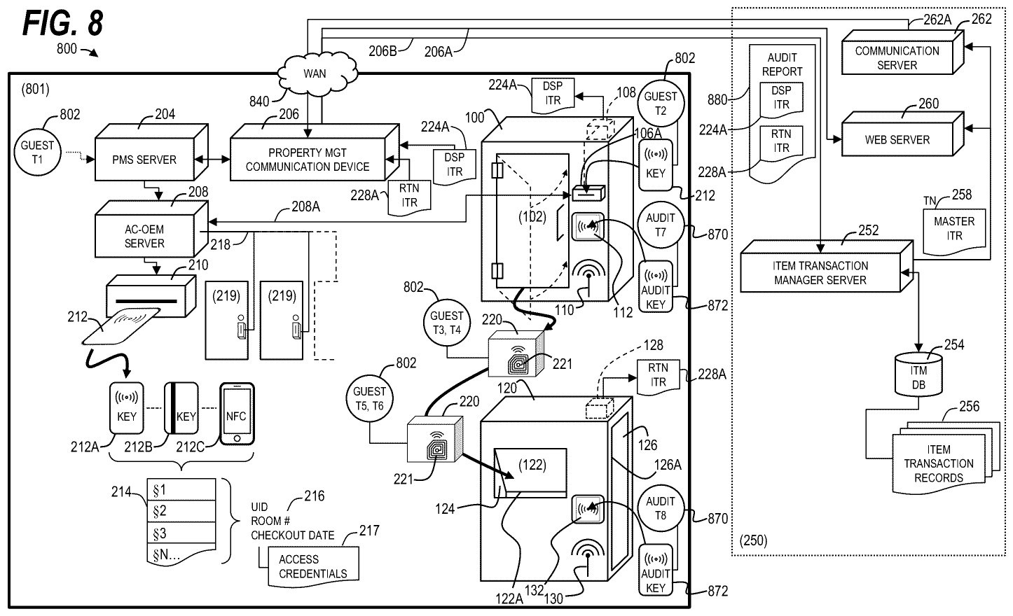

The first trackable item system 200 includes a physical facility 201 that may represent, for example, a hospitality property, a resort, a hospital, a rehabilitation facility, a nursing home, a gym, a sports club or an athletic center where reusable and trackable items may be dispensed to guests, members or employees at the physical facility and subsequently inventoried against guest, member or employee accounts for any non-returned status of the trackable items. Note that physical facility 201 of FIG. 2 may be similar to the later described and illustrated physical facilities, for example, physical facility 401 of FIG. 4, physical facility 601 of FIG. 6, and physical facility 801 of FIG. 8.

In the first trackable item system 200, a guest 202, at a first time T1, may present themselves to a property management server (PMS) 204, usually manned by a facility employee, to be issued access credentials 217 to access the physical facility 201 or certain areas within the physical facility 201. Access credentials 217 are issued to the guest 202 via an access control OEM server 208 that controls access via an access control OEM network 218 connected to access control perimeter nodes 219, for example, hotel room doors, parking garage gates, gym facilities or a pool access perimeters.

For example, the guest 202 may be issued access credentials 217 via an access control key card writer 210 wherein a “blank” access control key 212 may have access credentials 217 written thereon to allow the guest 202 to have access within the physical facility 201. The access control key 212 may include a wireless access control key 212A, a magnetic access control key 212B or a Near Field Communication (NFC)-type access control device 212C, such as a mobile communication device. An access control key 212 may provide access control key data sectors 214 which may be written with the access control key card writer 210 to input access control data according to specific access control key header data 216. Access control key header data 216 may include a unique user ID (UID), a room number or member number, and/or a checkout date associated with a respective room number, if, for example, the physical facility 201 is a hospitality property.

The property management server 204 may be in communication with a property management communication device 206 configured to communicate via a wide area network node 240A by property management communication device transmission 206A with a web server 260 of the item transaction management system 250 to review a master item transaction report 258, or to receive the master item transaction report 258 via the wide area network node 240A by a communication server transmission 262A from a communication server 262 of the item transaction management system 250.

Physical facility 201 further includes at least one trackable item dispensing unit 100, as described in FIGS. 1A-1C, for interacting with the access control key 212 of the guest 202 at a second time T2 via the guest 202 placing the access control key 212 in or proximate to the dispensing unit access device 106. Thereafter, the dispensing unit internal server 108 may either compare the guest 202 provided access credentials 217 on the access control key 212 to validate with previously stored or received access credentials 217, or not provide any comparison of access credentials 217 in certain configurations, and then allow, at a third time T3, guest 202 access to the dispensing unit interior compartment 104 via unlocking the dispensing unit access door 102.

The guest 202 may retrieve one or more trackable items 220, each trackable item incorporating a trackable item integrated RFID chip 221, from the dispensing unit interior compartment 104 when the dispensing unit access door 102 is in the access door open position 102A. When the guest 202 is finished retrieving the one or more trackable items 220, the guest 202 closes the dispensing unit access door 102 to the access door closed position 102B when the dispensing unit internal server 108 senses the access door closed position 102B and activates the RFID sensing event 110A of the dispensing unit RFID reader 110 to read the remaining one or more trackable items 220 in the dispensing unit interior compartment 104.

The dispensing unit internal server 108 prepares a dispensing unit item transaction record 224 based on the determined remaining one or more trackable items 220, and via a wide area network node 240B, communicates by dispensing unit internal server transmission event 108A with an item transaction management server 252 of the item transaction management system 250. The item transaction management server 252 then stores the dispensing unit item transaction record 224 in an item transaction management database 254 containing previously stored item transaction records 256.

The guest 202 at a third time T3 may deposit the one or more trackable items 220 with the trackable item integrated RFID chip 221 thereon into the return unit interior compartment 124 of the trackable item return unit 120 via a return unit access door 122. When the return unit access door 122 is sensed to be in an access door closed position 122B, the return unit RFID reader 130 is activated to enable a RFID sensing event 130A to determine one or more trackable items 220 in the return unit interior compartment 124.

The return unit internal server 128 prepares a return unit item transaction record 228 based on the determined one or more trackable items 220, and via a wide area network node 240C, communicates by a return unit internal server transmission event 128A with the item transaction management server 252 of the item transaction management system 250. The item transaction management server 252 then stores the return unit item transaction record 228 in an item transaction management database 254 containing previously stored item transaction records 256.

The first trackable item system 200, after having received the dispensing unit item transaction record 224 from the trackable item dispensing unit 100 and receiving the return unit internal server 128 from the trackable item return unit 120, then compares the dispensed one or more trackable items 220 with the returned one or more trackable items 220 to determine, at that particular time, which of the one or more trackable items 220 have not been returned to the trackable item return unit 120. Note that in facilities where more than one trackable item dispensing unit 100 and more than one trackable item return unit 120 are deployed, data from all the dispensing and return units are accumulated for comparison as a guest, member or employee may return the one or more trackable items 220 to any of the multiple return units. Each dispensing and return units may to communicate their respective dispensing unit item transaction record 224 and return unit item transaction record 228 to the item transaction management server 252 of the item transaction management system 250 such that a facility, like physical facility 201, may have an accurate accounting of all returned and unreturned one or more trackable items 220.

After the item transaction management server 252 has determined from the previously stored item transaction records 256, a master item transaction report 258 is created that may provide records of all returned one or more trackable items 220, and more importantly, all unreturned one or more trackable items 220. The master item transaction report 258 may then be communicated from the item transaction management server 252 to a web server 260 configured to enable a client facility manager via property management communication device 206 to view a web-enabled display of the master item transaction report 258. Alternatively, and or additionally, the master item transaction report 258 may be communicated from the item transaction management server 252 to a communication server 262 that may prepare an electronic communication containing the master item transaction report 258 and transmit the same via communication server transmission 262A to a designated client facility email server and/or the property management communication device 206.

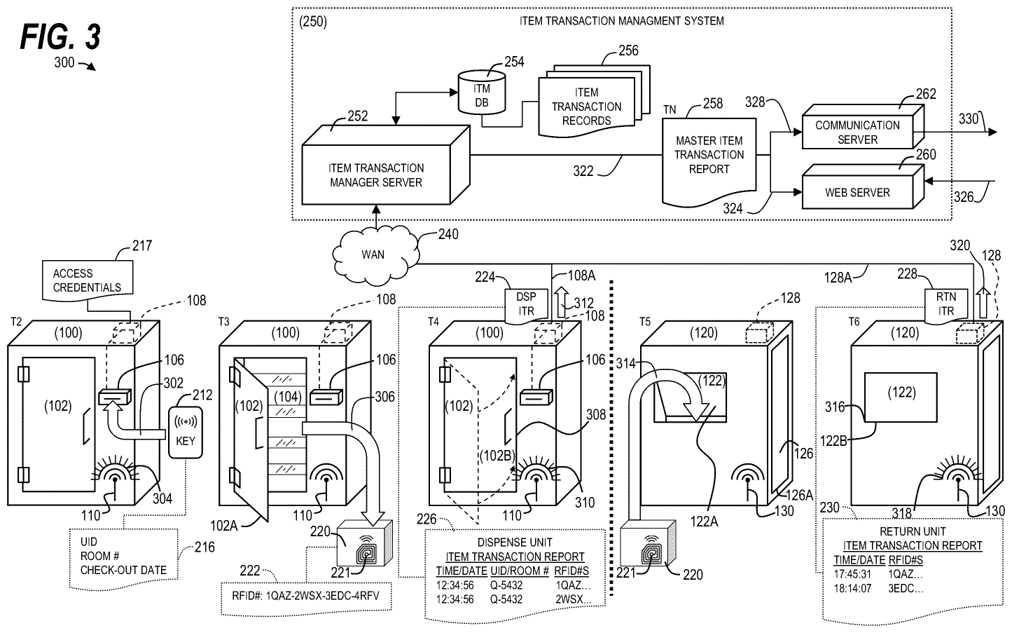

With reference to FIG. 3, a first trackable item system transaction diagram 300 of the first trackable item system 200 illustrates at the second time T2, the access control key 212 is presented to the dispensing unit access device 106 to enable a reader event 302 at the trackable item dispensing unit 100 of the access control key 212. The dispensing unit RFID reader 110 enables an RFID read event 304 of the dispensing unit RFID reader 110 before the dispensing unit access door 102 is allowed by the dispensing unit internal server 108 to be opened by the holder of the access control key 212. When the access control key 212 is read by the dispensing unit access device 106, access credentials 217 are read from any of the sections of the access control key header data 216.

FIG. 3 illustrates at a third time T3, after the dispensing unit internal server 108 has either verified the access credentials 217 of the access control key 212 or has identified the access control key 212, the dispensing unit internal server 108 unlocks a controllable lock in the trackable item dispensing unit 100 to allow a user to move the dispensing unit access door 102 to an access door open position 102A. Trackable item dispensing event 306 occurs when the user retrieves one or more trackable items 220 with a trackable item integrated RFID chip 221. The trackable item integrated RFID chip 221 further includes a trackable item RFID unique ID 222.

FIG. 3 illustrates at a fourth time T4, the user moves the dispensing unit access door 102 into an access door closed position 102B to produce a door close sensing event 308 sensed by the dispensing unit internal server 108 to cause the dispensing unit RFID reader 110 to enable an RFID read event 310 to read any remaining one or more trackable items 220 within the dispensing unit interior compartment 104.

The dispensing unit internal server 108 prepares a dispensing unit item transaction record 224 including dispensing unit item transaction record data 226 that may further include a date and timestamp of a trackable item, user ID data, that may include a UID, a room number, a membership number, and the determined trackable item RFID unique ID 222 associated with the user ID and date and timestamp. The dispensing unit item transaction record data 226 may include record that indicate a single transaction item record for a user that takes only one trackable item, or multiple transaction item records associated with a single user identifier for a user that takes more than one trackable item.

The dispensing unit internal server 108 executes a dispensing record transmission event 312 via a dispensing unit internal server transmission event 108A to transmit the dispensing unit item transaction record 224 to a wide area network 240 for delivery to the item transaction management server 252 at the item transaction management system 250.

FIG. 3 illustrates at a fifth time T5 a user bringing the one or more trackable items 220 with the trackable item integrated RFID chip 221 to the trackable item return unit 120 for the purpose of returning the one or more trackable items 220 and produce a trackable item return event 314. The user causes the return unit access door 122 to move to an access door open position 122A such that the one or more trackable items 220 may be placed inside the trackable item return unit 120.

FIG. 3 illustrates at a sixth time T6 that the return unit internal server 128 senses the return unit access door 122 being returned to an access door closed position 122B to create a door close sensing event 316 whereupon the return unit RFID reader 130 is active to produce an RFID read event 318 of any one or more trackable items 220 located within the trackable item return unit 120. Thereafter, or at a designated period of time, a return unit item transaction record 228 is generated by the return unit internal server 128 and prepared for a record transmission event 320 via the wide area network 240 for communication with the item transaction management server 252 of the item transaction management system 250.

FIG. 3 illustrates at a report generation time TN the item transaction management server 252, based on previously received and stored previously stored item transaction records 256 from the item transaction management database 254, a master item transaction report 258 is prepared in a master item transaction report generation event 322. The master item transaction report 258 in a web server transmission event 324 may be sent to a web server 260 configured to host the master item transaction report 258 for client access in a user access event 326 to the web server 260.

Additionally, or in the alternative, the master item transaction report 258 in a communication server event 328 may be sent to the communication server 262 for subsequent electronic preparation and transmission in a transmit report event 330 to an email server or a client communication device like the property management communication device 206 from FIG. 2.

The report generation time TN may take place during a single time of day after user activity at the trackable item dispensing unit 100 and the trackable item return unit 120 has either ceased or is substantively attenuated. In a hospitality facility, an example may provide the master item transaction report 258 is hosted via the web server 260 or transmitted via e-mail to the property management communication device 206 before or proximate calendar date change to enable the facility management to assess any unreturned trackable items to a user account in advance of a guest checking out of a hospitality facility. A membership-based facility may not require a daily master item transaction report 258 to be generated but may have a weekly or monthly preparation frequency of the master item transaction report 258 as membership accounts are not typically settled on a daily basis as in the hospitality industry. The master item transaction report 258 may be set to any frequency a property facility manager deems necessary for their accounting practices.

Note that in the following description of FIGS. 4-9, reference numbers used to describe elements described and illustrated in FIGS. 1-3 may be carried over into the following description and illustrations where the elements are substantially identical.

With reference to FIG. 4, a second trackable item system 400 includes dispensing and return units that directly communicate with an item transaction management system 250 and a bridge access control server 404 configured to communicate with the item transaction management system 250.

The second trackable item system 400 includes a physical facility 401, similar to physical facility 201, but including a bridge access control server 404 in secure communication with the access control OEM server 208, and in communication with the item transaction management server 252 of the item transaction management system 250, and optionally in communication with the dispensing unit internal server 108 of the trackable item dispensing unit 100.

In the second trackable item system 400, a guest 402 presents themselves in similar manner of FIG. 2 to the property management server 204 that generates access credentials 217 on an access control key 212 via and access control OEM server 208 and related hardware as previously described. However, in this particular aspect of the second trackable item system 400, a bridge access control server 404 is able to securely communicate via secure shell connection 406 with the access control OEM server 208 to obtain a table record 410 of user identification records that may include access credentials 217 organized according to access control key header data 216. The 410 may be communicated via communication path 408 to the item transaction management server 252 of item transaction management system 250 for storing in the item transaction management database 254 in anticipation of preparing the master item transaction report 258 at the designated master item report preparation time TN.

Additionally, or in the alternative, the table record 410 may be communicated via a local device communication path 412 directly to the dispensing unit internal server 108 of the trackable item dispensing unit 100 to enable the dispensing unit internal server 108 to obtain an updated table of access credentials 217 from the access control key header data 216 issued by the access control OEM server 208 such that the dispensing unit internal server 108 may verify the presented access credentials 217 by the guest 402 at the second time T2 to the dispensing unit access device 106 of the trackable item dispensing unit 100. Verification by the dispensing unit internal server 108 of the access credentials 217 may include either preventing user access or providing user access to the dispensing unit interior compartment 104 of the trackable item dispensing unit 100.

The guest 402 may provide access credentials 217 via access control key 212 to the dispensing unit access device 106 of the trackable item dispensing unit 100 in similar manner to the illustration and description of FIG. 2, where the guest 202 at a time T3 opens the dispensing unit access door 102 to access one or more trackable items 220, closes the dispensing unit access door 102 at a time T4, returns the one or more trackable items 220 to the trackable item return unit 120 at a time T5 whereafter the return unit RFID reader 130 reads the contents of the trackable item return unit 120 at a time T6 after the return unit access door 122 is returned to the access door closed position 122B.

Communication between the physical facility 401 and the item transaction management system 250 may be provided by wide area network 440 as represented by wide area network node 440A, wide area network node 440B and wide area network node 440C, respectively.

The master item transaction report 258 is generated by the item transaction management server 252 at a time TN in similar manner to FIG. 2 and may be communicated to web server 260 and communication server 262, respectively.

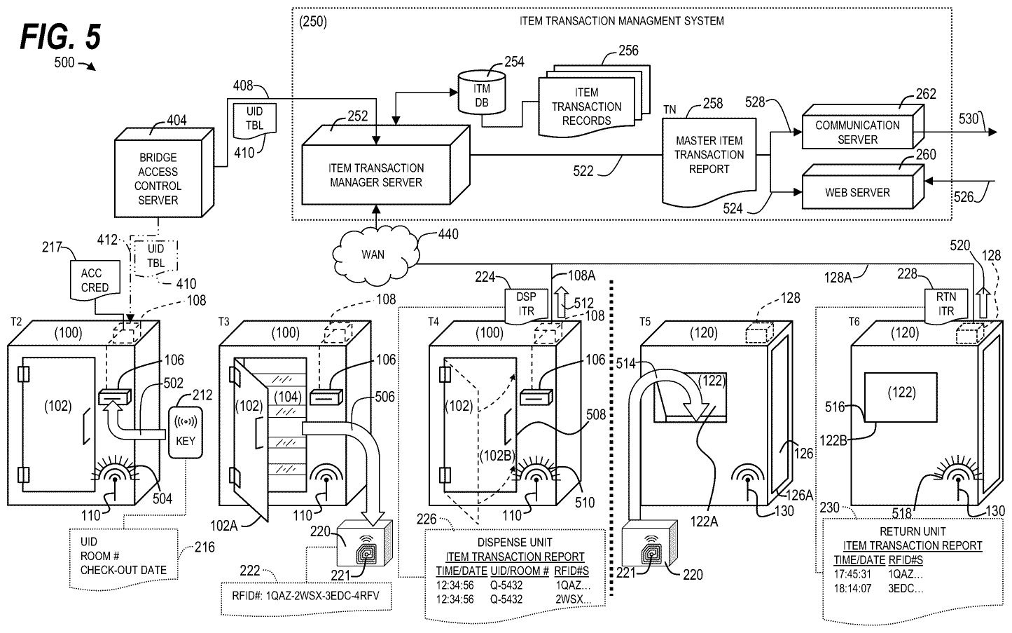

With reference to FIG. 5, a first trackable item system transaction diagram 500 of the second trackable item system 400 illustrates at the second time T2, the access control key 212 may be presented to the dispensing unit access device 106 to enable a reader event 502 at the trackable item dispensing unit 100 of the access control key 212. The dispensing unit RFID reader 110 enables an RFID read event 504 of the dispensing unit RFID reader 110 before the dispensing unit access door 102 may be allowed by the dispensing unit internal server 108 to be opened by the holder of the access control key 212. When the access control key 212 may be read by the dispensing unit access device 106, access credentials 217 are read from any of the sections of the access control key header data 216.

The bridge access control server 404 may also transmit via a local device communication path 412 the table record 410 to the dispensing unit internal server 108 of the trackable item dispensing unit 100 to enable the dispensing unit internal server 108 to compare user presented access credentials 217 with data in the table record 410 corresponding to information originally generated by the access control OEM server 208. Transmission of the table record 410 to the dispensing unit internal server 108 may occur before the user presents their access credentials 217 via the access control key 212 to the dispensing unit access device 106 of the trackable item dispensing unit 100 at time T2.

Furthermore, the bridge access control server 404 may transmit via communication path 408 the table record 410 to the item transaction management server 252 of the item transaction management system 250. Transmission of the table record 410 to item transaction management server 252 may occur at any time before the item transaction management server 252 begins preparation of the master item transaction report generation event 522.

FIG. 5 illustrates at a third time T3, after the dispensing unit internal server 108 has either verified the access credentials 217 of the access control key 212 or has identified the access control key 212, the dispensing unit internal server 108 unlocks a controllable lock in the trackable item dispensing unit 100 to allow a user to move the dispensing unit access door 102 to an access door open position 102A. Trackable item dispensing event 506 occurs when the user retrieves one or more trackable items 220 with a trackable item integrated RFID chip 221. The trackable item integrated RFID chip 221 further includes a trackable item RFID unique ID 222.

FIG. 5 illustrates at a fourth time T4, the user moves the dispensing unit access door 102 into an access door closed position 102B to produce a door close sensing event 508 sensed by the dispensing unit internal server 108 to cause the dispensing unit RFID reader 110 to enable an RFID read event 510 to read any remaining one or more trackable items 220 within the dispensing unit interior compartment 104.

The dispensing unit internal server 108 prepares a dispensing unit item transaction record 224 including dispensing unit item transaction record data 226 that may further include a date and timestamp of a trackable item, user ID data, that may include a UID, a room number, a membership number, and the determined trackable item RFID unique ID 222 associated with the user ID and date and timestamp. The dispensing unit item transaction record data 226 may include record that indicate a single transaction item record for a user that takes only one trackable item, or multiple transaction item records associated with a single user identifier for a user that takes more than one trackable item.

The dispensing unit internal server 108 executes a dispensing record transmission event 512 via a dispensing unit internal server transmission event 108A to transmit the dispensing unit item transaction record 224 to a wide area network 240 for delivery to the item transaction management server 252 at the item transaction management system 250.

FIG. 5 illustrates at a fifth time T5 a user bringing the one or more trackable items 220 with the trackable item integrated RFID chip 221 to the trackable item return unit 120 for the purpose of returning the one or more trackable items 220 and produce a trackable item return event 514. The user causes the return unit access door 122 to move to an access door open position 122A such that the one or more trackable items 220 may be placed inside the trackable item return unit 120.

FIG. 5 illustrates at a sixth time T6 that the return unit internal server 128 senses the return unit access door 122 being returned to an access door closed position 122B to create a door close sensing event 516 whereupon the return unit RFID reader 130 may be active to produce an RFID read event 518 of any one or more trackable items 220 located within the trackable item return unit 120. Thereafter, or at a designated period of time, a return unit item transaction record 228 may be generated by the return unit internal server 128 and prepared for a record transmission event 520 via the wide area network 240 for communication with the item transaction management server 252 of the item transaction management system 250.

FIG. 5 illustrates at a report generation time TN the item transaction management server 252, based on previously received and stored previously stored item transaction records 256 and the table record 410, as forwarded by the bridge access control server 404, from the item transaction management database 254, a master item transaction report 258 may be prepared in a master item transaction report generation event 522. The master item transaction report 258 in a web server transmission event 524 may be sent to a web server 260 configured to host the master item transaction report 258 for client access in a user access event 526 to the web server 260.

Additionally, or in the alternative, the master item transaction report 258 in a communication server event 528 may be sent to the communication server 262 for subsequent electronic preparation and transmission in a transmit report event 530 to an email server or a client communication device like the property management communication device 206 from FIG. 2.

The report generation time TN, in similar manner as illustrated and described in FIG. 3, may take place during a single time of day after user activity at the trackable item dispensing unit 100 and the trackable item return unit 120 has either ceased or may be substantively attenuated. The master item transaction report 258 may be set to any frequency a property facility manager deems necessary for their accounting practices.

With reference to FIG. 6, a third trackable item system 600 including dispensing and return units that directly communicate with an item transaction management system 250 and a dispensing unit that communicates with a membership server via an API call.

The third trackable item system 600 includes a physical facility 601, similar to physical facility 401, however, the third trackable item system 600 replaces the bridge access control server 404 with a direct API call communication path 608 between the dispensing unit internal server 108 of the trackable item dispensing unit 100 and the membership server 604 that includes data regarding current membership accounts of members.

In the third trackable item system 600, a member 602 presents themselves at time T2 in similar manner of FIG. 4 to membership server 604 that generates access credentials 217 related to a user identification section 616 on the access control key data sectors 214 written on an access control key 212 via and access control OEM server 208 and related hardware as previously described. However, in this particular aspect of the third trackable item system 600, the dispensing unit internal server 108 of the trackable item dispensing unit 100 makes an API call via a direct API call communication path 608 to the membership server 604 to query a membership list stored in the membership server 604 when the member 602 at the second time T2 presents their access control key 212 to the dispensing unit access device 106 of the trackable item dispensing unit 100.

The dispensing unit internal server 108 of the trackable item dispensing unit 100 may receive a verification authorization from the membership server 604 via the direct API call communication path 608 or may itself compare membership data received from the membership server 604 via the direct API call communication path 608 to provide verification authorization configured to either unlock and allow user access to the dispensing unit interior compartment 104 or prevent user access to the dispensing unit interior compartment 104.

The member 602 may provide access credentials 217 via access control key 212 to the dispensing unit access device 106 of the trackable item dispensing unit 100 in similar manner to the illustration and description of FIG. 4, where the member 602, when allowed by either the membership server 604 or the dispensing unit internal server 108, at a time T3, opens the dispensing unit access door 102 to access one or more trackable items 220, closes the dispensing unit access door 102 at a time T4, returns the one or more trackable items 220 to the trackable item return unit 120 at a time T5 whereafter the return unit RFID reader 130 reads the contents of the trackable item return unit 120 at a time T6 after the return unit access door 122 is returned to the access door closed position 122B.

Communication between the physical facility 601 and the item transaction management system 250 may be provided by wide area network 640 as represented by wide area network node 640A, wide area network node 640B and wide area network node 640C, respectively.

The master item transaction report 258 may be generated by the item transaction management server 252 at a time TN in similar manner to FIG. 4 and may be communicated to web server 260 to enable web browser-based access by the facility management communication device 606 to view the master item transaction report 258 via a communication path 606A, and to the communication server 262 for transmitting an electronic message with the master item transaction report 258 to the facility management communication device 606.

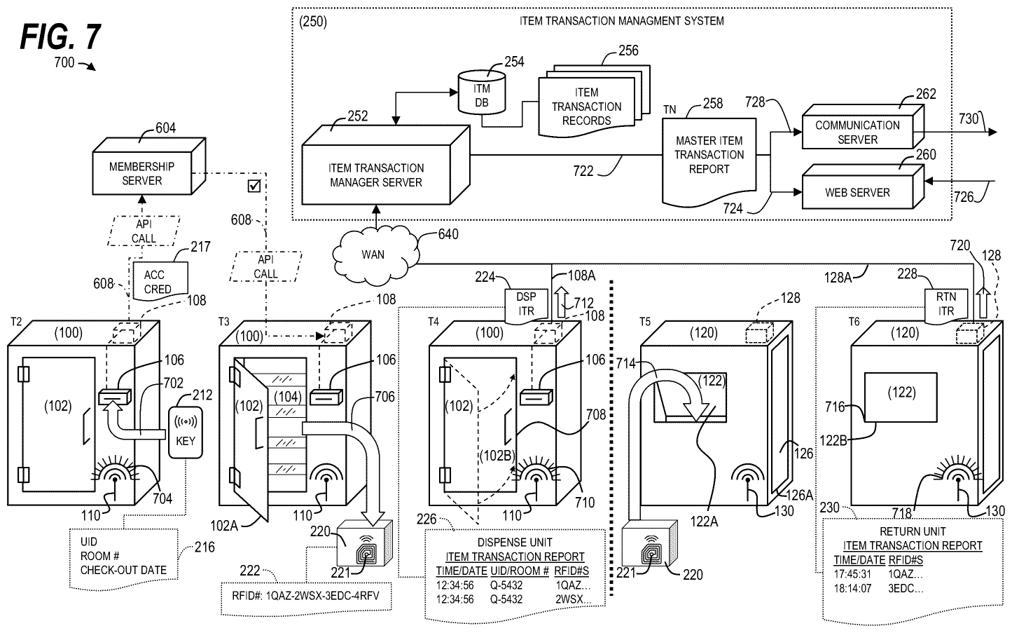

With reference to FIG. 7, a third trackable item system transaction diagram 700 of the third trackable item system 600 illustrates at the second time T2, the access control key 212 may be presented to the dispensing unit access device 106 to enable a reader event 702 at the trackable item dispensing unit 100 of the access control key 212.

As previously described above, the access credentials 217 are either forwarded via the direct API call communication path 608 to the membership server 604 for comparison at the membership server 604 to issue via the direct API call communication path 608 a user access signal or a no user access signal. In that alternative, the membership server 604 may responds to a query by the dispensing unit internal server 108 to transmit user membership credentials via direct API call communication path 608 to the dispensing unit internal server 108 such that the dispensing unit internal server 108 may undertake the verification process of validating the access credentials 217 of the access control key header data 216 presented to the dispensing unit access device 106 of the trackable item dispensing unit 100.

Before the dispensing unit access door 102 is opened upon allowance of the user to access the dispensing unit interior compartment 104, the dispensing unit RFID reader 110 enables an RFID read event 704 of the dispensing unit RFID reader 110 before the dispensing unit access door 102 is allowed by the dispensing unit internal server 108 to be opened by the holder of the access control key 212. When the access control key 212 is read by the dispensing unit access device 106, access credentials 217 are read from any of the sections of the access control key header data 216.

FIG. 7 illustrates at a third time T3, after the dispensing unit internal server 108 or the membership server 604 has verified the access credentials 217 of the access control key 212, the dispensing unit internal server 108 unlocks a controllable lock in the trackable item dispensing unit 100 to allow a user to move the dispensing unit access door 102 to an access door open position 102A. Trackable item dispensing event 706 occurs when the user retrieves one or more trackable items 220 with a trackable item integrated RFID chip 221. The trackable item integrated RFID chip 221 further includes a trackable item RFID unique ID 222.

FIG. 7 illustrates at a fourth time T4, the user moves the dispensing unit access door 102 into an access door closed position 102B to produce a door close sensing event 708 sensed by the dispensing unit internal server 108 to cause the dispensing unit RFID reader 110 to enable an RFID read event 710 to read any remaining one or more trackable items 220 within the dispensing unit interior compartment 104.

The dispensing unit internal server 108 prepares a dispensing unit item transaction record 224 including dispensing unit item transaction record data 226 that may further include a date and timestamp of a trackable item, user ID data, that may include a UID, a room number, a membership number, and the determined trackable item RFID unique ID 222 associated with the user ID and date and timestamp. The dispensing unit item transaction record data 226 may include record that indicate a single transaction item record for a user that takes only one trackable item, or multiple transaction item records associated with a single user identifier for a user that takes more than one trackable item.

The dispensing unit internal server 108 executes a dispensing record transmission event 712 via a dispensing unit internal server transmission event 108A to transmit the dispensing unit item transaction record 224 to a wide area network 240 for delivery to the item transaction management server 252 at the item transaction management system 250.

FIG. 7 illustrates at a fifth time T5 a user bringing the one or more trackable items 220 with the trackable item integrated RFID chip 221 to the trackable item return unit 120 for the purpose of returning the one or more trackable items 220 and produce a trackable item return event 714. The user causes the return unit access door 122 to move to an access door open position 122A such that the one or more trackable items 220 may be placed inside the trackable item return unit 120.

FIG. 7 illustrates at a sixth time T6 that the return unit internal server 128 senses the return unit access door 122 being returned to an access door closed position 122B to create a door close sensing event 716 whereupon the return unit RFID reader 130 is active to produce an RFID read event 718 of any one or more trackable items 220 located within the trackable item return unit 120. Thereafter, or at a designated period of time, a return unit item transaction record 228 may be generated by the return unit internal server 128 and prepared for a record transmission event 720 via the wide area network 240 for communication with the item transaction management server 252 of the item transaction management system 250.

FIG. 7 illustrates at a report generation time TN the item transaction management server 252, based on previously received and stored previously stored item transaction records 256 and the table record 410, as forwarded by the bridge access control server 404, from the item transaction management database 254, a master item transaction report 258 may be prepared in a master item transaction report generation event 722. The master item transaction report 258 in a web server transmission event 724 may be sent to a web server 260 configured to host the master item transaction report 258 for client access in a user access event 726 to the web server 260.

Additionally, or in the alternative, the master item transaction report 258 in a communication server event 728 may be sent to the communication server 262 for subsequent electronic preparation and transmission in a transmit report event 730 to an email server or a client communication device like the property management communication device 206 from FIG. 2.

The report generation time TN, in similar manner as illustrated and described in FIG. 5, may take place during a single time of day after user activity at the trackable item dispensing unit 100 and the trackable item return unit 120 has either ceased or may be substantively attenuated. The master item transaction report 258 may be set to any frequency a property facility manager deems necessary for their accounting practices.

With reference to FIG. 8, a fourth trackable item system 800 including dispensing and return units that do not directly communicate with an item transaction management system 250 but are independently audited for item transaction reporting data.

The fourth trackable item system 800 includes a physical facility 801, similar to physical facility 601, however, the fourth trackable item system 800 replaces the bridge access control server 404 of second trackable item system 400 and the direct API call communication path 608 of third trackable item system 600 with an OEM communication path 208A directly between the access control OEM server 208 and the OEM dispensing unit access device 106A of the trackable item dispensing unit 100.

In the fourth trackable item system 800, a guest 802 presents themselves at time T2 in similar manner of FIG. 4 to access control OEM server 208 that generates access credentials 217 on an access control key 212 via and access control OEM server 208 and related hardware as previously described. However, in this aspect of fourth trackable item system 800, the access control OEM server 208 has direct access to either verify and control the user access to the dispensing unit interior compartment 104 of the trackable item dispensing unit 100 when access credentials 217 are presented at the OEM dispensing unit access device 106A, or provide user access credential information directly to the dispensing unit internal server 108 of the trackable item dispensing unit 100 for the dispensing unit internal server 108 to verify and control user access.

When an access control signal may be provided by either the access control OEM server 208 or the dispensing unit internal server 108 of the trackable item dispensing unit 100, the guest 802, at a time T3, opens the dispensing unit access door 102 to access one or more trackable items 220, closes the dispensing unit access door 102 at a time T4, returns the one or more trackable items 220 to the trackable item return unit 120 at a time T5 whereafter the return unit RFID reader 130 reads the contents of the trackable item return unit 120 at a time T6 after the return unit access door 122 is returned to the access door closed position 122B.

At a time T7, a facility auditor 870 may present an audit key 872 to either the dispense unit wireless transceiver 112 or the OEM dispensing unit access device 106A on the trackable item dispensing unit 100 to request a local dispensing unit item transaction record 224A be generated and locally communicated to a portable audit device or communicated to the property management communication device 206 by electronic or other communication means. If the local dispensing unit item transaction record 224A may be communicated to a portable audit device, the portable audit device may be configured to transmit the local dispensing unit item transaction record 224A to the property management communication device 206 for subsequent transmission via the wide area network 840 to the item transaction management server 252 via a property management communication device record transmission 206B in the item transaction management system 250.

At a time T8, the facility auditor 870 may further present the audit key 872 to the dispense unit wireless transceiver 112 on the trackable item return unit 120 to request a local return unit item transaction record 228A be generated and locally communicated to a portable audit device or communicated to the property management communication device 206 by electronic or other communication means. If the local return unit item transaction record 228A may be communicated to a portable audit device, the portable audit device may be configured to transmit the local dispensing unit item transaction record 224A to the property management communication device 206 for subsequent transmission to the item transaction management server 252 via a property management communication device record transmission 206B in the item transaction management system 250.

The local dispensing unit item transaction record 224A and the local return unit item transaction record 228A may be independently transmitted via the property management communication device record transmission 206B to the item transaction management server 252 or may be consolidated for transmission in a single audit report 880. In a similar manner as previously described above in FIGS. 2, 4 and 6, the item transactions in the local dispensing unit item transaction record 224A and the local return unit item transaction record 228A are stored in the previously stored item transaction records 256 of the item transaction management database 254 for preparation of the master item transaction report 258 at the designated time TN.

The master item transaction report 258 may be generated by the item transaction management server 252 at a time TN in similar manner to FIG. 4 and may be communicated to web server 260 and communication server 262, respectively.

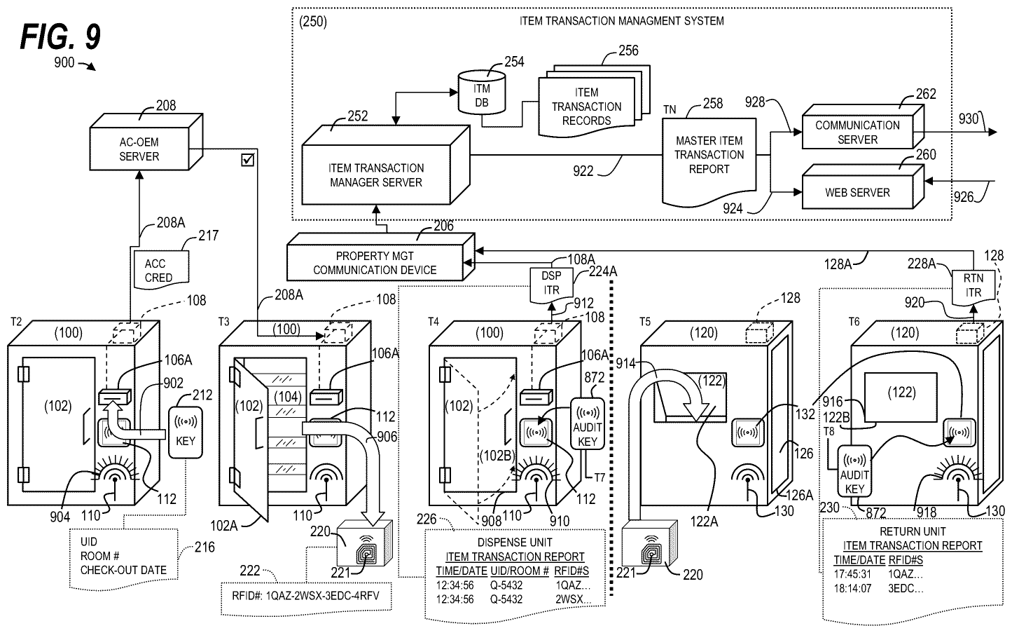

With reference to FIG. 9, a fourth trackable item system transaction diagram 900 of the fourth trackable item system 800 illustrates at the second time T2, the access control key 212 may be presented to the OEM dispensing unit access device 106A to enable a reader event 902 at the trackable item dispensing unit 100 of the access control key 212.

As previously described above, the access credentials 217 are either forwarded via the OEM communication path 208A to the access control OEM server 208 for comparison at the access control OEM server 208 to issue a user access signal or a no user access signal. In the alternative, the access control OEM server 208 may respond to a query by the dispensing unit internal server 108 to transmit user membership credentials via OEM communication path 208A to the dispensing unit internal server 108 such that the dispensing unit internal server 108 may undertake the verification process of validating the access credentials 217 of the access control key header data 216 presented by the user to the OEM dispensing unit access device 106A of the trackable item dispensing unit 100.

Before the dispensing unit access door 102 is opened upon allowance of the user to access the dispensing unit interior compartment 104, the dispensing unit RFID reader 110 enables an RFID read event 904 of the dispensing unit RFID reader 110 before the dispensing unit access door 102 is allowed by the dispensing unit internal server 108 to be opened by the holder of the access control key 212. When the access control key 212 may be read by the OEM dispensing unit access device 106A, access credentials 217 are read from any of the sections of the access control key header data 216.

FIG. 9 illustrates at a third time T3, after the dispensing unit internal server 108 or access control OEM server 208 has verified the access credentials 217 of the access control key 212, the dispensing unit internal server 108 unlocks a controllable lock in the trackable item dispensing unit 100 to allow a user to move the dispensing unit access door 102 to an access door open position 102A. Trackable item dispensing event 906 occurs when the user retrieves one or more trackable items 220 with a trackable item integrated RFID chip 221. The trackable item integrated RFID chip 221 further includes a trackable item RFID unique ID 222.

FIG. 9 illustrates at a fourth time T4, the user moves the dispensing unit access door 102 into an access door closed position 102B to produce a door close sensing event 908 sensed by the dispensing unit internal server 108 to cause the dispensing unit RFID reader 110 to enable an RFID read event 910 to read any remaining one or more trackable items 220 within the dispensing unit interior compartment 104.

The dispensing unit internal server 108 prepares a local dispensing unit item transaction record 224A including dispensing unit item transaction record data 226 that may further include a date and timestamp of a trackable item, user ID data, that may include a UID, a room number, a membership number, and the determined trackable item RFID unique ID 222 associated with the user ID and date and timestamp. The dispensing unit item transaction record data 226 may include record that indicate a single transaction item record for a user that takes only one trackable item, or multiple transaction item records associated with a single user identifier for a user that takes more than one trackable item.

The dispensing unit internal server 108 executes a dispensing record transmission event 912 via a dispensing unit internal server transmission event 108A to transmit the dispensing unit item transaction record 224 to a wide area network 240 for delivery to the item transaction management server 252 at the item transaction management system 250.

FIG. 9 illustrates at a fifth time T5 a user bringing the one or more trackable items 220 with the trackable item integrated RFID chip 221 to the trackable item return unit 120 for the purpose of returning the one or more trackable items 220 and produce a trackable item return event 914. The user causes the return unit access door 122 to move to an access door open position 122A such that the one or more trackable items 220 may be placed inside the trackable item return unit 120.

FIG. 9 illustrates at a sixth time T6 that the return unit internal server 128 senses the return unit access door 122 being returned to an access door closed position 122B to create a door close sensing event 916 whereupon the return unit RFID reader 130 may be active to produce an RFID read event 918 of any one or more trackable items 220 located within the trackable item return unit 120. Thereafter, or at a designated period of time, a return unit item transaction record 228 may be generated by the return unit internal server 128 and prepared for a record transmission event 920 via the wide area network 240 for communication with the item transaction management server 252 of the item transaction management system 250.

FIG. 9 illustrates at a sixth time T7 that a facility auditor 870 presents an audit key 872 to the return unit wireless transceiver 132 of the trackable item dispensing unit 100 to request a local dispensing unit item transaction record 224A be generated that contains dispensing unit item transaction record data 226 and either stores the local dispensing unit item transaction record 224A in a portable communication device or requests the local dispensing unit item transaction record 224A be transmitted to the property management communication device 206 in a dispensing unit internal server transmission event 108A.

FIG. 9 illustrates at a sixth time T8 that that a facility auditor 870 presents the audit key 872 to the return unit wireless transceiver 132 of the trackable item return unit 120 to request a local return unit item transaction record 228A be generated that contains return unit item transaction record data 230 and either stores the local return unit item transaction record 228A in the portable communication device or requests the local return unit item transaction record 228A be transmitted to the property management communication device 206 in a return unit internal server transmission event 128A.

FIG. 9 illustrates at a report generation time TN the item transaction management server 252, based on previously received and stored previously stored item transaction records 256 and the table record 410, as forwarded by the bridge access control server 404, from the item transaction management database 254, a master item transaction report 258 may be prepared in a master item transaction report generation event 922. The master item transaction report 258 in a web server transmission event 924 may be sent to a web server 260 configured to host the master item transaction report 258 for client access in a user access event 926 to the web server 260.

Additionally, or in the alternative, the master item transaction report 258 in a communication server event 928 may be sent to the communication server 262 for subsequent electronic preparation and transmission in a transmit report event 930 to an email server or a client communication device like the property management communication device 206 from FIG. 2.

The report generation time TN, in similar manner as illustrated and described in FIG. 7, may take place during a single time of day after user activity at the trackable item dispensing unit 100 and the trackable item return unit 120 has either ceased or may be substantively attenuated. The master item transaction report 258 may be set to any frequency a property facility manager deems necessary for their accounting practices.

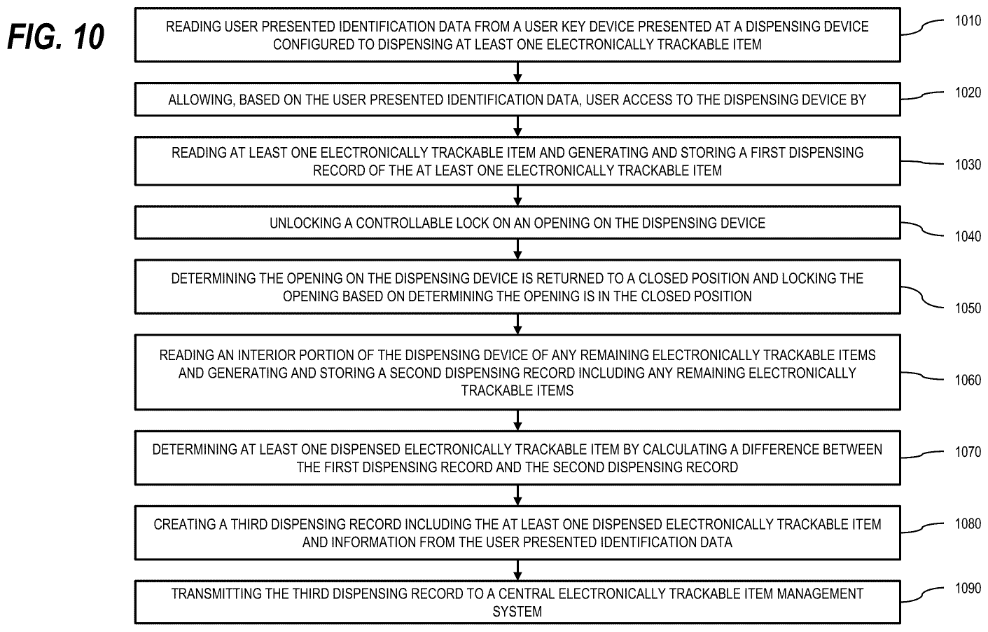

With reference to FIG. 10, a method of preparing and transmitting a dispensing record for an electronically trackable item is illustrated.

[15] In some aspects, the techniques described herein relate to a method of preparing and transmitting a dispensing record for an electronically trackable item, the method including: reading 1010 user presented identification data from a user key device presented at a dispensing device configured to dispensing at least one electronically trackable item; allowing 1020, based on the user presented identification data, user access to the dispensing device by: reading 1030 at least one electronically trackable item and generating and storing a first dispensing record of the at least one electronically trackable item; and unlocking 1040 a controllable lock on an opening on the dispensing device; determining 1050 the opening on the dispensing device may be returned to a closed position and locking the opening based on determining the opening may be in the closed position; reading 1060 an interior portion of the dispensing device of any remaining electronically trackable items and generating and storing a second dispensing record including any remaining electronically trackable items; determining 1070 at least one dispensed electronically trackable item by calculating a difference between the first dispensing record and the second dispensing record; creating 1080 a third dispensing record including the at least one dispensed electronically trackable item and information from the user presented identification data; and transmitting 1090 the third dispensing record to a central electronically trackable item management system.

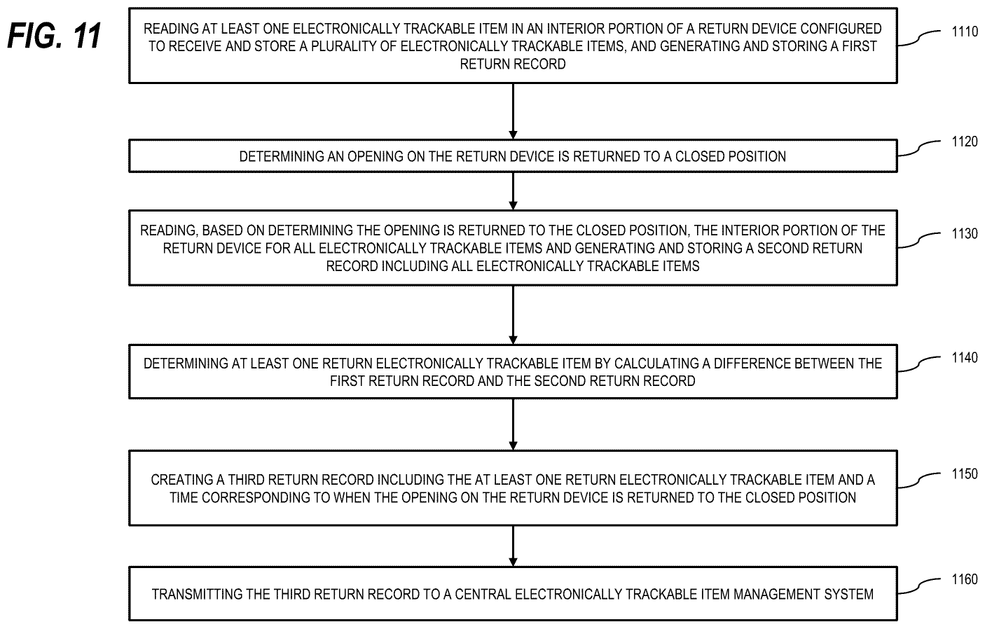

With reference to FIG. 11, a method preparing and transmitting a return record for an electronically trackable item is illustrated.

[19] In some aspects, the techniques described herein relate to a method preparing and transmitting a return record for an electronically trackable item, the method including: reading 1110 at least one electronically trackable item in an interior portion of a return device configured to receive and store a plurality of electronically trackable items, and generating and storing a first return record; determining 1120 an opening on the return device is returned to a closed position; reading 1130, based on determining the opening is returned to the closed position, the interior portion of the return device for all electronically trackable items and generating and storing a second return record including all electronically trackable items; determining 1140 at least one return electronically trackable item by calculating a difference between the first return record and the second return record; creating 1150 a third return record including the at least one return electronically trackable item and a time corresponding to when the opening on the return device is returned to the closed position; and transmitting 1160 the third return record to a central electronically trackable item management system.

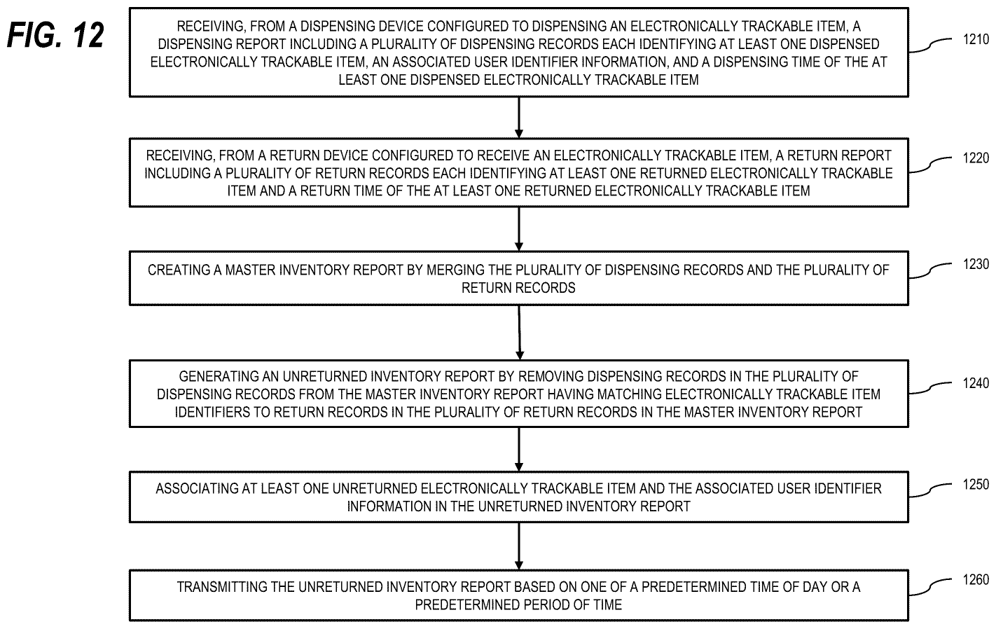

With reference to FIG. 12, a method of generating and transmitting an inventory report for an electronically trackable item management system is illustrated.

[21] In some aspects, the techniques described herein relate to a method of generating and transmitting an inventory report for an electronically trackable item management system, the method including: receiving 1210, from a dispensing device configured to dispensing an electronically trackable item, a dispensing report including a plurality of dispensing records each identifying at least one dispensed electronically trackable item, an associated user identifier information, and a dispensing time of the at least one dispensed electronically trackable item; receiving 1220, from a return device configured to receive an electronically trackable item, a return report including a plurality of return records each identifying at least one returned electronically trackable item and a return time of the at least one returned electronically trackable item; creating 1230 a master inventory report by merging the plurality of dispensing records and the plurality of return records; generating 1240 an unreturned inventory report by removing dispensing records in the plurality of dispensing records from the master inventory report having matching electronically trackable item identifiers to return records in the plurality of return records in the master inventory report; associating 1250 at least one unreturned electronically trackable item and the associated user identifier information in the unreturned inventory report; and transmitting 1260 the unreturned inventory report based on one of a predetermined time of day or a predetermined period of time.

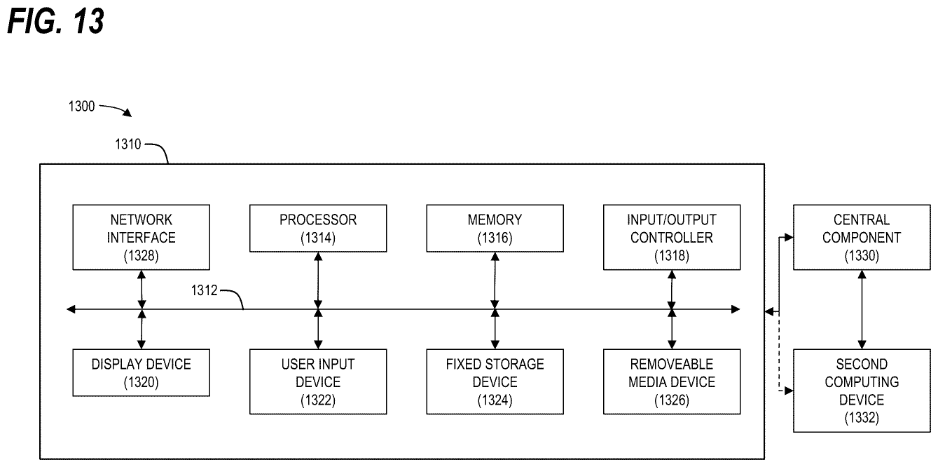

With reference to FIG. 13 a schematic diagram of an exemplary hardware environment that can be used to implement the above-identified aspects.

Implementations of the presently disclosed subject matter may be implemented in and used with a variety of component and network architectures. FIG. 13 is an example computer environment 1300 and an example computer 1310 suitable for implementing implementations of the presently disclosed subject matter, and particularly the dispensing unit internal server 108, the return unit internal server 128, the item transaction management server 252, the web server 260 and the communication server 262 of FIGS. 2-9.

As discussed in further detail herein, the computer 1310 may be a single computer in a network of multiple computers. As shown in FIG. 13, computer 1310 may communicate with a central component 1330 (e.g., server, cloud server, database, etc.). The central component 1330 may communicate with one or more other computers such as the second computer 1332. According to this implementation, the information obtained to and/or from a central component 1330 may be isolated for each computer such that computer 1310 may not share information with second computer 1332. Alternatively, or in addition, computer 1310 may communicate directly with the second computer 1332.

The computer 1310, (e.g., user computer, enterprise computer, etc.), includes a bus 1312 which interconnects major components of the computer 1310, such as a central processor 1314, a memory 1316, (typically RAM, but which may also include ROM, flash RAM, or the like), an input/output controller 1318, a user display 1320, such as a display or touch screen via a display adapter, a user input interface 1322, which may include one or more controllers and associated user input or devices such as a keyboard, mouse, WIFI/cellular radios, touchscreen, microphone/speakers and the like, and may be closely coupled to the input/output controller 1318, fixed storage 1324, such as a hard drive, flash storage, Fiber Channel network, SAN device, SCSI device, and the like, and a removable media storage device 1326 operative to control and receive an optical disk, flash drive, and the like.

The bus 1312 enable data communication between the central processor 24 and the memory 1316, which may include read-only memory (ROM) or flash memory (neither shown), and random-access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 1310 can be stored on and accessed via a computer readable medium, such as a hard disk drive, (e.g., fixed storage 1324), an optical drive, floppy disk, or another removable media storage device 1326.

The fixed storage 1324 may be integrated with the computer 1310 or may be separate and accessed through other interfaces. A network interface 1328 may provide a direct connection to a remote server via a telephone link, to the Internet via an internet service provider (ISP), or a direct connection to a remote server via a direct network link to the Internet via a POP (point of presence) or other technique. The network interface 1328 may provide such connection using wireless techniques, including digital cellular telephone connection, Cellular Digital Packet Data (CDPD) connection, digital satellite data connection or the like. For example, the network interface 1328 may enable the computer to communicate with other computers via one or more local, wide-area, or other networks.

Many other devices or components (not shown) may be connected in a similar manner (e.g., document scanners, digital cameras and so on). Conversely, all of the components shown in FIG. 13 need not be present to practice the present disclosure. The components can be interconnected in different ways from that shown. The operation of a computer such as that shown in FIG. 13 is readily known in the art and is not discussed in detail in this application. Code to implement the present disclosure can be stored in computer-readable storage media such as one or more of the memory 1316, fixed storage 1324, removable media storage device 1326, or on a remote storage location.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to generate specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk, or any other device capable of storing electronic information. The memory may store instructions adapted to be executed by the processor to perform the techniques according to implementations of the disclosed subject matter.

Benefits of Access Control Product Data Acquisition Integration with NDIAS

Integration of ACOS equipment with readable encrypted user data provides a more comprehensive and effective enterprise solution for integration with the NDIAS. The benefits are as follows.

Increased Security: Integration of ACOS equipment with readable encrypted user data provides a seamless and secure delivery of facility data which is not reliant on human interaction or matching processes, e.g., a manual audit process. Within the construct of this environment, the guest/member/staff presents his guest/member/staff access credential and the NDIAS dispenser device securely collects the user data during the credential read. The data is then used to determine if the guest/member/staff is active, (i.e., the checkout data has not lapsed), and if so, the dispenser device door opens, allowing the guest/member/staff to remove any number of non-disposable items they desire. In this process, all user data resides within the confines of the NDIAS secure cloud server and a Virtual Private Network (VPN) which includes the physical NDIAS dispenser and return devices and their corresponding servers.

The aforementioned automatic data acquisition process can be contrasted with the manual user data acquisition processes where access records are manually downloaded from the ACOS equipment and periodically sent to the NDIAS cloud server via a cloud file storage solution, (e.g., DropBox™) or e-mail, for manual data consolidation. The manual process is less secure and human error prone with potential gaps of data.

Centralized Management: Integration provides a single platform for collecting NDIAS dispenser and return device non-disposable item usage, (via NDIAS System manager), and facility data, (via ACOS equipment), within a NDIAS dispenser and return device, making it easier to manage site-wide data security. Typically, only one department in the facility needs to manage the system verses the manual data acquisition process methodology which often requires facility Loss Prevention or Engineering to download files and the Front Desk staff to charge for lost non-disposable items.

Reduced Costs: Integrating ACOS equipment reduces the need for multiple standalone systems and nightly human resources to audit units and send data to NDIAS resulting in lower hardware and maintenance costs.

In some aspects, the techniques described herein relate to a system configured to prepare an unreturned record of an unreturned electronically trackable item associated with a user, the system including: a dispensing device configured: to receive, hold, and electronically identify a plurality of electronically trackable items within the dispensing device; to receive user identification data presented at the dispensing device by a user configured to notify the dispensing device of intended user access to the dispensing device for at least one electronically trackable item; to control user access of a user to the dispensing device to allow dispensing from the dispensing device of at least one electronically trackable item of the plurality of electronically trackable items; to electronically identify and store a dispensing record of at least one dispensed electronically trackable item of the plurality of electronically trackable items associated with the user identification data; and to transmit the dispensing record to a remote central electronically trackable item management system; a return device configured: to receive, electronically identify and store a return record of at least one returned electronically trackable item corresponding to the at least one dispensed electronically trackable item; and to transmit the return record to the remote central electronically trackable item management system; an access control device configured to receive user presented identification data presented by the user at the dispensing device and to allow user access to the dispensing device based on receiving the user presented identification data; the remote central electronically trackable item management system configured: to receive a plurality of dispensing records and a plurality of return records from at least one dispensing device and at least one return device, respectively; and to compile an unreturned record of at least one unreturned electronically trackable item and an associated user based on information in the user presented identification data presented by the user and collected at the dispensing device in the dispensing record, the unreturned record being calculated by taking a difference between the plurality of dispensing records and the plurality of return records; and a report system, in communication with the remote central electronically trackable item management system, the report system configured, at one of a predetermined time of day or a predetermined time period, to at least one of: communicate the unreturned record via electronic communication; and provide a web-based browser interface to view the unreturned record.

In some aspects, the techniques described herein relate to a system, wherein the access control device is further configured to verify the user presented identification data and to communicate, based on verifying the user presented identification data, an access status of a user access to the dispensing device, wherein the access status being one of an access grant status or an access deny status.

In some aspects, the techniques described herein relate to a system, wherein the user presented identification data includes at least one of unique user identification data, user room number data, user membership data, and user checkout date data.

In some aspects, the techniques described herein relate to a system, wherein the dispensing record includes unique trackable item identification data, dispensing time data and at least one of user ID data, a user room number and a user membership number.

In some aspects, the techniques described herein relate to a system, wherein the return record includes unique trackable item identification data, return time data and at least one of return unit identification data, and facility identification data.

In some aspects, the techniques described herein relate to a system, wherein the dispensing device is further configured to receive user identification data, wherein the user identification data includes at least one of unique user identification data, user room number data, user membership data, and user checkout date data.

In some aspects, the techniques described herein relate to a system, wherein the dispensing device is further configured to verify the user identification data to one of allow or deny access to the dispensing device for retrieval of at least one electronically trackable item from the plurality of electronically trackable items.

In some aspects, the techniques described herein relate to a system, wherein the remote central electronically trackable item management system is further configured to receive user identification data, wherein the user identification data includes at least one of unique user identification data, user room number data, user membership data, and user checkout date data.

In some aspects, the techniques described herein relate to a system, wherein the dispensing device is further configured to receive membership information data from a membership management system.

In some aspects, the techniques described herein relate to a system, wherein the dispensing device is further configured to verify, based on the membership information data, the user identification data to one of allow or deny access to the dispensing device for retrieval of at least one electronically trackable item from the plurality of electronically trackable items.

In some aspects, the techniques described herein relate to a system, wherein the dispensing device is further configured to transmit the dispensing record to a local device independent from the remote central electronically trackable item management system to create a local dispensing record.

In some aspects, the techniques described herein relate to a system, wherein the remote central electronically trackable item management system is further configured to receive the local dispensing record.

In some aspects, the techniques described herein relate to a system, wherein the return device is further configured to transmit the return record to a local device independent from the remote central electronically trackable item management system to create a local return record.

In some aspects, the techniques described herein relate to a system, wherein the remote central electronically trackable item management system is further configured to receive the local return record.

In some aspects, the techniques described herein relate to a method of preparing and transmitting a dispensing record for an electronically trackable item, the method including: reading user presented identification data from a user key device presented at a dispensing device configured to dispensing at least one electronically trackable item; allowing, based on the user presented identification data, user access to the dispensing device by: reading at least one electronically trackable item and generating and storing a first dispensing record of the at least one electronically trackable item; and unlocking a controllable lock on an opening on the dispensing device; determining the opening on the dispensing device is returned to a closed position and locking the opening based on determining the opening is in the closed position; reading an interior portion of the dispensing device of any remaining electronically trackable items and generating and storing a second dispensing record including any remaining electronically trackable items; determining at least one dispensed electronically trackable item by calculating a difference between the first dispensing record and the second dispensing record; creating a third dispensing record including the at least one dispensed electronically trackable item and information from the user presented identification data; and transmitting the third dispensing record to a central electronically trackable item management system.

In some aspects, the techniques described herein relate to a method, wherein the user presented identification data includes at least one of user ID data, membership number data, user room number data, and checkout date data.

In some aspects, the techniques described herein relate to a method, further including: receiving user identification data at an access control device on the dispensing device before reading the user presented identification data from the user key device; verifying the user presented identification data from the user key device with the user identification data; transmitting an access control signal from the access control device, wherein the access control signal is configured to one of restrict user access or allow user access to the dispensing device based on verifying the user presented identification data.

In some aspects, the techniques described herein relate to a method, wherein transmitting the third dispensing record is based on at least one of: determining the opening on the dispensing device is returned to the closed position; a predetermined time of day; a predetermined period of time; and a retrieval of the third dispensing record from the dispensing device.

In some aspects, the techniques described herein relate to a method preparing and transmitting a return record for an electronically trackable item, the method including: reading at least one electronically trackable item in an interior portion of a return device configured to receive and store a plurality of electronically trackable items, and generating and storing a first return record; determining an opening on the return device is returned to a closed position; reading, based on determining the opening is returned to the closed position, the interior portion of the return device for all electronically trackable items and generating and storing a second return record including all electronically trackable items; determining at least one return electronically trackable item by calculating a difference between the first return record and the second return record; creating a third return record including the at least one return electronically trackable item and a time corresponding to when the opening on the return device is returned to the closed position; and transmitting the third return record to a central electronically trackable item management system.

In some aspects, the techniques described herein relate to a method, wherein transmitting the third return record is based on at least one of: determining the opening on the return device is returned to the closed position; a predetermined time of day; a predetermined period of time; and a retrieval of the third return record from the return device.

In some aspects, the techniques described herein relate to a method of generating and transmitting an inventory report for an electronically trackable item management system, the method including: receiving, from a dispensing device configured to dispensing an electronically trackable item, a dispensing report including a plurality of dispensing records each identifying at least one dispensed electronically trackable item, an associated user identifier information, and a dispensing time of the at least one dispensed electronically trackable item; receiving, from a return device configured to receive an electronically trackable item, a return report including a plurality of return records each identifying at least one returned electronically trackable item and a return time of the at least one returned electronically trackable item; creating a master inventory report by merging the plurality of dispensing records and the plurality of return records; generating an unreturned inventory report by removing dispensing records in the plurality of dispensing records from the master inventory report having matching electronically trackable item identifiers to return records in the plurality of return records in the master inventory report; associating at least one unreturned electronically trackable item and the associated user identifier information in the unreturned inventory report; and transmitting the unreturned inventory report based on one of a predetermined time of day or a predetermined period of time.

The foregoing description, for the purpose of explanation, has been described with reference to specific arrangements and configurations. However, the illustrative examples provided herein are not intended to be exhaustive or to limit aspects of the disclosed subject matter to the precise forms disclosed. Many modifications and variations are possible in view of the disclosure provided herein. The aspects and arrangements were chosen and described in order to explain the principles of aspects of the disclosed subject matter and their practical applications. Various modifications may be used without departing from the scope or content of the disclosure and claims presented herein.

What is claimed is:

1. A system configured to prepare an unreturned record of an unreturned electronically trackable item associated with a user, the system comprising:
a dispensing device configured:
to receive, hold, and electronically identify a plurality of electronically trackable items within the dispensing device;
to receive user identification data presented at the dispensing device by a user configured to notify the dispensing device of intended user access to the dispensing device for at least one electronically trackable item;
to control user access of a user to the dispensing device to allow dispensing from the dispensing device of at least one electronically trackable item of the plurality of electronically trackable items;
to electronically identify and store a dispensing record of at least one dispensed electronically trackable item of the plurality of electronically trackable items associated with the user identification data; and
to transmit the dispensing record to a remote central electronically trackable item management system;
a return device configured:
to receive, electronically identify and store a return record of at least one returned electronically trackable item corresponding to the at least one dispensed electronically trackable item; and
to transmit the return record to the remote central electronically trackable item management system;
an access control device configured to receive user presented identification data presented by the user at the dispensing device and to allow user access to the dispensing device based on receiving the user presented identification data;
the remote central electronically trackable item management system configured:
to receive a plurality of dispensing records and a plurality of return records from at least one dispensing device and at least one return device, respectively; and
to compile an unreturned record of at least one unreturned electronically trackable item and an associated user based on information in the user presented identification data presented by the user and collected at the dispensing device in the dispensing record, the unreturned record being calculated by taking a difference between the plurality of dispensing records and the plurality of return records; and
a report system, in communication with the remote central electronically trackable item management system, the report system configured, at one of a predetermined time of day or a predetermined time period, to at least one of:
communicate the unreturned record via electronic communication; and
provide a web-based browser interface to view the unreturned record.

2. The system according to claim 1, wherein the access control device is further configured to verify the user presented identification data and to communicate, based on verifying the user presented identification data, an access status of a user access to the dispensing device, wherein the access status being one of an access grant status or an access deny status.

3. The system according to claim 2, wherein the user presented identification data includes at least one of unique user identification data, user room number data, user membership data, and user checkout date data.

4. The system according to claim 1, wherein the dispensing record includes unique trackable item identification data, dispensing time data and at least one of user ID data, a user room number and a user membership number.

5. The system according to claim 1, wherein the return record includes unique trackable item identification data, return time data and at least one of return unit identification data, and facility identification data.

6. The system according to claim 1, wherein the dispensing device is further configured to receive user identification data, wherein the user identification data includes at least one of unique user identification data, user room number data, user membership data, and user checkout date data.

7. The system according to claim 6, wherein the dispensing device is further configured to verify the user identification data to one of allow or deny access to the dispensing device for retrieval of at least one electronically trackable item from the plurality of electronically trackable items.

8. The system according to claim 1, wherein the remote central electronically trackable item management system is further configured to receive user identification data, wherein the user identification data includes at least one of unique user identification data, user room number data, user membership data, and user checkout date data.

9. The system according to claim 1, wherein the dispensing device is further configured to receive membership information data from a membership management system.

10. The system according to claim 9, wherein the dispensing device is further configured to verify, based on the membership information data, the user identification data to one of allow or deny access to the dispensing device for retrieval of at least one electronically trackable item from the plurality of electronically trackable items.

11. The system according to claim 1, wherein the dispensing device is further configured to transmit the dispensing record to a local device independent from the remote central electronically trackable item management system to create a local dispensing record.

12. The system according to claim 11, wherein the remote central electronically trackable item management system is further configured to receive the local dispensing record.

13. The system according to claim 1, wherein the return device is further configured to transmit the return record to a local device independent from the remote central electronically trackable item management system to create a local return record.

14. The system according to claim 13, wherein the remote central electronically trackable item management system is further configured to receive the local return record.

15. A method of preparing and transmitting a dispensing record for an electronically trackable item, the method comprising:
reading user presented identification data from a user key device presented at a dispensing device configured to dispensing at least one electronically trackable item;
allowing, based on the user presented identification data, user access to the dispensing device by:
reading at least one electronically trackable item and generating and storing a first dispensing record of the at least one electronically trackable item; and
unlocking a controllable lock on an opening on the dispensing device;
determining the opening on the dispensing device is returned to a closed position and locking the opening based on determining the opening is in the closed position;
reading an interior portion of the dispensing device of any remaining electronically trackable items and generating and storing a second dispensing record including any remaining electronically trackable items;
determining at least one dispensed electronically trackable item by calculating a difference between the first dispensing record and the second dispensing record;
creating a third dispensing record including the at least one dispensed electronically trackable item and information from the user presented identification data; and
transmitting the third dispensing record to a central electronically trackable item management system.

16. The method according to claim 15, wherein the user presented identification data includes at least one of user ID data, membership number data, user room number data, and checkout date data.

17. The method according to claim 15, further comprising:
receiving user identification data at an access control device on the dispensing device before reading the user presented identification data from the user key device;
verifying the user presented identification data from the user key device with the user identification data; and
transmitting an access control signal from the access control device, wherein the access control signal is configured to one of restrict user access or allow user access to the dispensing device based on verifying the user presented identification data.

18. The method according to claim 15, wherein transmitting the third dispensing record is based on at least one of:
determining the opening on the dispensing device is returned to the closed position;
a predetermined time of day;
a predetermined period of time; and
a retrieval of the third dispensing record from the dispensing device.

19. A method preparing and transmitting a return record for an electronically trackable item, the method comprising:
reading at least one electronically trackable item in an interior portion of a return device configured to receive and store a plurality of electronically trackable items, and generating and storing a first return record;
determining an opening on the return device is returned to a closed position;
reading, based on determining the opening is returned to the closed position, the interior portion of the return device for all electronically trackable items and generating and storing a second return record including all electronically trackable items;
determining at least one return electronically trackable item by calculating a difference between the first return record and the second return record;
creating a third return record including the at least one return electronically trackable item and a time corresponding to when the opening on the return device is returned to the closed position; and
transmitting the third return record to a central electronically trackable item management system.

20. The method according to claim 19, wherein transmitting the third return record is based on at least one of:
determining the opening on the return device is returned to the closed position;
a predetermined time of day;
a predetermined period of time; and
a retrieval of the third return record from the return device.

21. A method of generating and transmitting an inventory report for an electronically trackable item management system, the method comprising:
receiving, from a dispensing device configured to dispensing an electronically trackable item, a dispensing report including a plurality of dispensing records each identifying at least one dispensed electronically trackable item, an associated user identifier information, and a dispensing time of the at least one dispensed electronically trackable item;
receiving, from a return device configured to receive an electronically trackable item, a return report including a plurality of return records each identifying at least one returned electronically trackable item and a return time of the at least one returned electronically trackable item;
creating a master inventory report by merging the plurality of dispensing records and the plurality of return records;
generating an unreturned inventory report by removing dispensing records in the plurality of dispensing records from the master inventory report having matching electronically trackable item identifiers to return records in the plurality of return records in the master inventory report;
associating at least one unreturned electronically trackable item and the associated user identifier information in the unreturned inventory report; and
transmitting the unreturned inventory report based on one of a predetermined time of day or a predetermined period of time.
